(19) United States
(12) Patent Application Publication
(10) Pub. No.: US 2004/0090423 A1
(43) Pub. Date: May 13, 2004

(54) Remote controlled video display GUI using 2-directional pointing

(75) Inventor: Stephen J. Bisset, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 10/646,149

(22) Filed: Aug. 22, 2003

Related U.S. Application Data
(63) Continuation of application No. 09/032,709, filed on Feb. 27, 1998, now abandoned.

(51) Int. Cl. G09G 5/00

(52) U.S. Cl. 345/169; 345/173

(57) ABSTRACT

A display system in which a video display is controlled via a pointing device. The pointing device is used to indicate motion in two different directions. The video controller will display a menu on the video display when the pointing device is used. Movement in a first direction selects menu items, while movement in a second direction selects an aspect of the selected menu item.

### BACKGROUND OF THE INVENTION

The present invention relates to interfaces for controlling a video display, and in particular to remote control devices which are user-friendly.

Radios and TVs were originally controlled by a few simple knobs, dials, switches or buttons, built into the equipment. During the last few decades, remote control units have become pervasive for TVs. We have here a user interface with these characteristics:

Video display.

User enjoys equipment from a distance, such as from the sofa.

There are multiple choices of programs and settings, and the user wants to make selections or alter settings frequently (such as channel surfing, sound mute, VCR pause).

User does not want to move to the equipment every time he or she controls it.

The number of control choices is small. For example, the TV watcher might want to select between a few channels, adjust the sound level, and turn the TV on or off.

The last of these characteristics is changing, however:

More channels.

More equipment types, such as TV, VCR, game unit, set-top box, interactive TV, PC, and home theater.

More information available on the video display, such as TV program guides.

As a result, the typical TV remote control unit is becoming less adequate and less user friendly than it was when the number of control choices was more limited. In many cases there are multiple remotes (TV, VCR, CD player). This has been addressed by the“universal remote”, but the universal remote is now more complex. Some of the difficulties of today's typical remote control are:

Many' different functions, requiring a large number of buttons.

The large number of buttons is confusing.

With a large number of buttons, it is difficult to memorize all the locations, therefore it is necessary to see the remote.

It may be hard to see the remote, because it may be dark, or because the user may not be able to focus on the remote and the video display at the same time (aging population).

The problem is expanded with interactive functions, such as games, or home shopping via interactive TV.

The multi-button hand-held remote control becomes less satisfactory as the range of available functions increases, because the number of buttons goes up, hence the buttons become harder to locate and harder to remember. In one commonly used remote control interface, the user initiates a pointing action (such as pushing the volume up or down button) and a sliding level indicator is overlaid on the TV image. A short time after the level adjustment is completed, the level indicator automatically disappears.

Another, existing user interface paradigm may seem like an obvious choice to address the limitation of today's TV remote, and this is the GUI/mouse paradigm for the PC. This interface is designed for an applications environment where there is a large number of choices, but where the user does not want to memorize a large number of commands to select the choices. The GUI provides a graphical menu of choices, and the mouse (or pointing device of equivalent functionality, such as trackball or joystick) is used in the “point-and-click” mode to make selections.

The large size and high resolution of the screen allows many selections to be displayed at once, and allows descriptive information about each to be visible (text, graphical icons, or a combination of the two). Thus the user can select from many choices, but-does not need to memorize them in any detail. The use of the screen is appropriate for darkened rooms, and the user already has his or her eyes focused on the screen.

It is possible to adapt the GUI/mouse interface to make it more suitable for home entertainment applications. The GUI is typically used with a pointing device intended for the desk top. There are various ways to adapt a pointing device for hand-held use. Several companies have introduced hand-held pointing devices, targeted at making presentations with the computer. One example would be a hand-held trackball, such as Logitech's StarTrack.

However, while the GUI/mouse paradigm has unlimited flexibility (in conjunction with a keyboard, for applications that require one), it may not be ideal for home entertainment. The front panel model represents the simplest, easiest and quickest-to-use interface, but is limited to simple applications. Today's remote control unit is a form of this front panel. The GUI/mouse interface is the most flexible, but it simply takes longer for the user to perform the simplest and most commonly used tasks (such as channel selection), as compared to a hand-held remote.

Home entertainment is a middle ground. It has the same environment for which a simple remote control was designed, but has some of the complexity for which the GUI/mouse was designed. There is a need for an interface paradigm that better serves this middle ground.

### SUMMARY OF THE INVENTION

The present invention provides a display system in which a video display is controlled via a pointing device. The pointing device is used to indicate motion in two different directions. The video controller will display a menu on the video display when the pointing device is used. Movement in a first direction selects menu items, while movement in a second direction selects an aspect of the selected menu item.

In one embodiment, functions of a display, such as volume, channel, etc., are displayed vertically, and are selected by vertical movement of the pointing device. Horizontal movement of the pointing device will vary a value of the selected function, such as varying the channel number of changing the volume. In different embodiments, the pointing device is a touchpad, a thumb-actuated stick, a trackball or a mouse. The pointing device is preferably mounted in a wireless remote control unit with the pointing device being located where it can be actuated with the thumb of a user holding the remote.

The present invention thus provides an interface which is as easy to use as a traditional TV remote control unit for controlling functions, yet has the flexibility of a GUI. This makes it suitable for home entertainment applications where the available range of functions is broad enough that the traditional remote control unit is cumbersome to use.

For a further understanding of the nature and advantages of the invention, reference should be made to the following description taken in conjunction with the accompanying drawings.

### BRIEF DESCRIPTION OF THE DRAWINGS

FIG. 1 is a perspective view of a remote control unit with a pointing device according to the invention.

FIG. 2 is a block diagram of the electronic control system according to the invention.

FIGS. 3 and 4 are illustrations of a display showing a menu according to the invention.

FIG. 5 is an illustration of an alternative display showing a menu according to the invention.

### DESCRIPTION OF THE PREFERRED EMBODIMENT

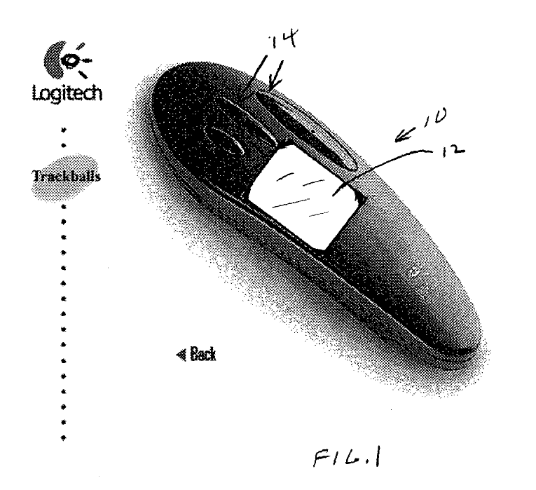

FIG. 1 shows a remote control unit 10 having a touchpad 12 mounted at a position-where it can be activated with a user's thumb. Also shown are optional control buttons 14.

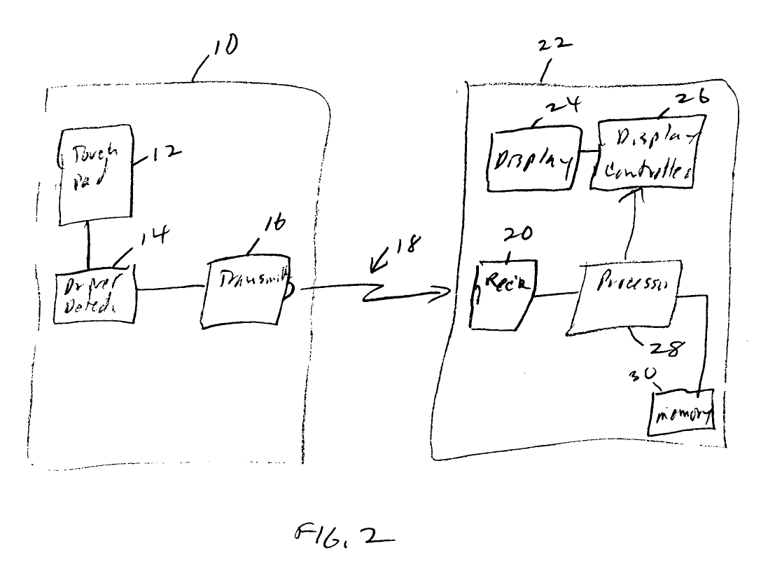

FIG. 2 illustrates in block diagram form the electronics of a system according to the invention. Remote unit 10 includes touchpad 12 with its associated drive and detection circuitry 14. Detected signals from the touchpad are provided to a transmitter 16 and sent over wireless or infrared link 18 to a receiver 20 in a video display unit 22. Display unit 22 includes a video display 24 controlled by a display controller 26. A separate processor 28 receives the signals from receiver 20 and provides them to display controller 26.

Driver and detection circuitry 14 of remote unit 10 could be the standard circuitry for use with a touchpad. An example of such a circuit is shown in co-pending Application No. 08/321,987, entitled TOUCH PAD SENSOR WITH SIMULTANEOUS SENSING, incorporated herein by reference. Display controller 26 could be a standard video display controller for putting images up on a screen. Processor 28 would decide what those images should be, and can overlay the menu of the present invention, which could be stored in a memory 30.

In one embodiment, processor 28 simply receives the touchpad signals from the transmitter without modification. It then interprets them to determine whether the movement is primarily vertical or horizontal, whether a tap is detected, etc. Alternately, driver and detector circuitry 14 could be modified to provide only very simple signals via an agreed protocol to receiver 20. For example, it could merely provide a signal indicating either vertical or horizontal, and distance, with separate control signals for a tap, activation of the touchpad, and deactivation.

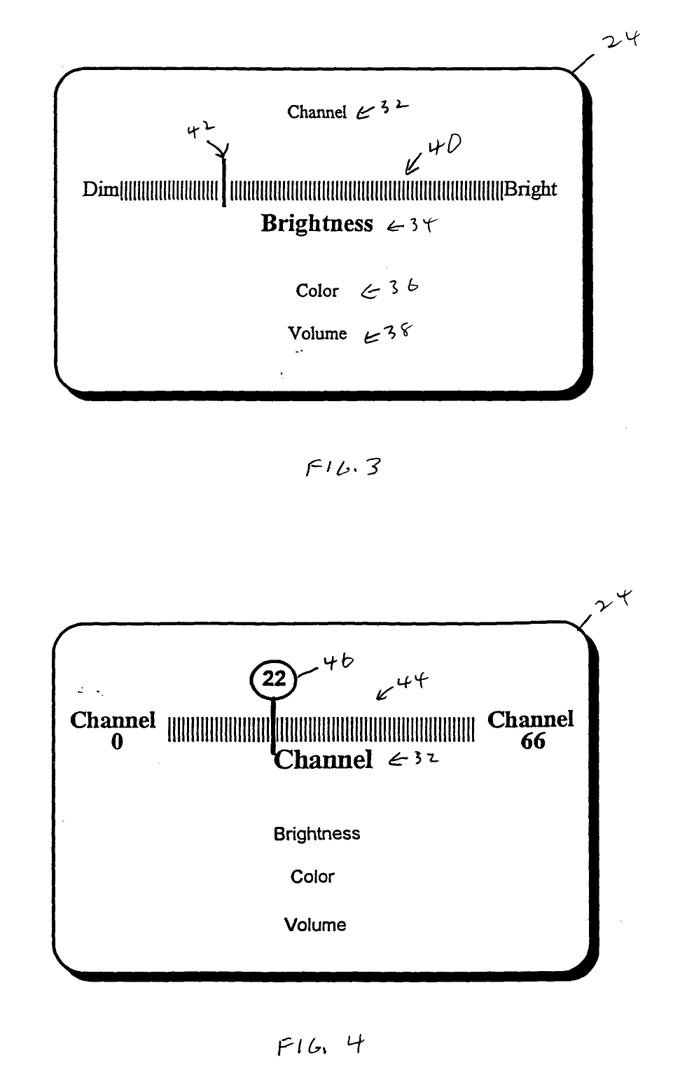

FIGS. 3 and 4 illustrate examples of a menu on a display 24. The menu items shown are arranged in a vertical arrangement, as an item 32 (channel), brightness 34, color 36 and volume 38. As shown in FIG. 3, when the vertical selection is on brightness, the brightness display is enlarged, and additionally, a horizontal display 40 is activated, with an indicator 42 corresponding to the horizontal position of the thumb on the touchpad.

Similarly, FIG. 4 shows the channel 32 being activated, with its horizontal display 44 being presented. Its indicator includes a magnifying glass indicator 46 which shows the actual channel number.

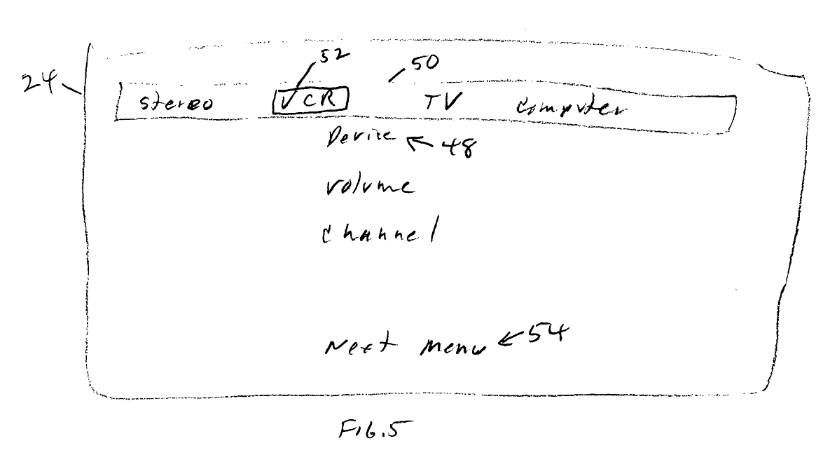

FIG. 5 illustrates an alternate display in which one of the menu items is a device 48. This could be used to control multiple devices connected to the display. As illustrated, when device 48 is chosen, the horizontal display, instead of simply providing a value, illustrates the alternate devices. Horizontal display 50 shows selectable items of a stereo, VCR, TV, and computer. Horizontal movement can move the indicator to the desired device to be controlled. When a particular device is selected, the remaining vertical menu items will correspond to that device, or could be replaced with other functions appropriate for such a device.

An alternate embodiment, or the same embodiment, could include a menu selection 54 of a next menu. Thus, by vertically scrolling to the bottom, when this is selected, a new vertical menu could be displayed. The next menu could have a previous menu item to return to the original menu. In one embodiment, the next menu could for additional functions, or for a different device, such as for switching from VCR to TV to stereo, etc.

In one embodiment, the menu of display 3, 4 or 5 is activated when any touch is detected at all on the touchpad. In alternate embodiments, where a ball, stick, etc. is used, any slight movement would activate the menu. Alternately, an additional touch sensing mechanism could be added to such devices to activate the menu. Conversely, the menu can be deactivated when touch is no longer sensed. On a stick, this could occur when it is returned to the center position for a predetermined amount of time, or simply when a predetermined amount of time has passed with no further movement being detected (or when fast movement is detected, corresponding the the finger being removed and the stick returns to its home position). The last position of the indicator on the horizontal display for the selected vertical menu item will thus be locked in to the last indicated value.

When the channel function is selected, the user can quickly select any channel from a large number. As the thumb slides left or right, the channel number is indicated (for example, in the magnifying glass icon shown above), and when the thumb is lifted, the indicated channel is selected. There are numerous variations that can be implemented, to best match user preference. The channel can include all channels, all channels with a signal, or a pre-selected set. When sliding the thumb, the channel can actually switch while the thumb is moving, or can just show the channel number and select the indicated channel only when the thumb is lifted.

The key benefit is that any channel can be selected by placing the thumb down once, moving it, and lifting it once, which is a simple and quick maneuver. Since the channel selection process is fully visible on the screen, it isn't necessary to look at the remote control unit at all.

There are simple shortcuts that can be implemented with gestures, such as a quick tap on the surface of the touchpad. It is easy while holding the remote control unit to tap in the right or left half of the pad. A tap in the right half can mean go to the next higher channel, and vice versa for the left half. Or the pad could be divided into thirds, with left and right as above, and with a tap on the center area switching back to the most recently selected channel (so the user can watch two shows at once).

Similar gestures can be useful when other functions are selected. For example, a center tap when sound volume is selected could mean mute. A very commonly used function, such as mute, could be programmed as a double tap, regardless of the function selected. Other gestures are possible, such as tapping with two fingers to turn off the power. Whenever the power is off, it can be turned on by simply touching the surface of the pad.

The invention allows a user to quickly select a function and a value for that function, using the video display as a menu and as feedback. The invention is applicable to many types of equipment. For example, a stereo, VCR, laser disk or other home entertainment appliance could be controlled thorough the same interface, if connected appropriately.

When controlling multiple pieces of equipment, it is possible to use either a“flat” or hierarchical menu arrangement.

In a hierarchical arrangement, there would be one of the functions which has the purpose of selecting other equipment (the list of connected equipment is the set of values for the function). As soon as other equipment is selected, the menu that become visible when the pad is touched is different for each piece of equipment, if appropriate).

In a flat arrangement, the menu of functions includes all functions of interest for all the connected equipment. for example, if a stereo system is used as the sound output for a TV, the “channel” function would control the TV, but the “balance” function would control the stereo system, and either function could be accessed immediately, without having to select the TV or the stereo first.

If one of the pieces of equipment to be controlled is a computer (or game controller or set-top box), then the remote controller can serve as a general purpose pointing device, with functionality that is at least equivalent to that of a mouse or trackball. This is handy when the natural interface to the equipment is the GUI/mouse interface.

There are applications where a traditional pointing device is not adequate, in particular applications requiring entry of alpha and/or numeric text strings. For an application such as word processing, there is no attractive substitute for a keyboard. The remote control invention described here could be combined with a keyboard, for users who do a lot of keyboard work, and who might like to do it from the comfort of their sofa, perhaps even taking a break now and then to catch the news on TV, or such.

Such a keyboard could have a built-in touchpad, and might even be cordless and designed with the ergonomics of sofa use in mind (sits comfortably on the lap). The touchpad would serve as a general pointing device when used with the computer, and would have the simpler, TV-style interface (as described above) when the TV function is selected. One can see how this would work well with a computer/TV combination.

There are other applications which require the occasional entry of short text strings, but where the user would not want a bulky keyboard lying around. An example might be home shopping. Most of the interaction would be through selection of items from a menu, but there might be a need to enter items such as name or credit card number, or a keyword if there is an item search function. There are several ways that this could be accomplished with a touchpad remote controller:

There could be an alpha, numeric, or alphanumeric function, where the values selected are the characters (a slide and lift action is required for each character). A variation could be that a QWERTYUIOP keyboard is displayed on the screen when the alphanumeric function is selected. The 225 dimensional nature of the touchpad is used to select each character. Other variations include point-and-tap (tap when the cursor is over the desired “key”), or point-and-tap where the pointing is done with one finger, and the tap is done with a second finger (this can be a lot faster). Another means of alphanumeric entry is simple character recognition. The entire pad could be used to trace out a letter or number (one character at a time). with a touch pad in the basic mode described above, we have function select in the Y (or X) direction, and value select in the X (or Y) direction. It is probably easiest for most users if the thumb is considered by the interface to be moving in only one direction (X or Y) at a time, but there can be a lot of latitude in what is X and what is Y.

Left or right motion within plus or minus 30 degrees of horizontal could be value select. There is a dead zone near 45 degrees to avoid confusion. The result is that it is very easy to hit the desired action, without a lot of manual accuracy being required.

The example above described a touchpad-based IR remote. It could be any kind of remote (such as IR, radio, sonar, or even a cord), or the interface could be built into the equipment (for example, an interface as the front panel of an automobile entertainment system, or the control panel for a hand-held video camera, where the function and value display is visible as an overlay in the viewfinder).

The basic function described could also be implemented with a mouse, trackball or joystick, or with a typical gamepad. The trackball or joystick could be desk mounted or hand-held. The key elements are that the input device be able to indicate motion in two directions, and be able to detect when the finger or thumb is touching it, or at least have a way to indicate when action is being indicated.

In one embodiment, a mouse on a surface is used. When a mouse button is pushed, the menu overlay appears on the display. Vertical and horizontal motions indicate function and value, with the function and value being selected when the finger is lifted from the button.

In another embodiment, a finger or thumb operated joystick in used. One way to indicate when the interface is being activated is to use a finger-operated trigger button on a hand-held unit which is designed for a thumb-operated joystick. An alternate embodiment will build in a means of detecting when the thumb (or finger) is in contact with the joystick itself.

In another embodiment, a desk top or hand-held trackball is used. It may have a button of some sort, and a means of detecting when the finger or thumb is in contact with the trackball.

As will be understood by those of skill in the art, the present invention may be embodied in other specific forms without departing from the spirit or essential characteristics thereof. Accordingly, the foregoing description is intended to be illustrative, but not limiting, of the scope of the invention which is set forth in the following claims.

What is claimed is:

1. A controlled display system comprising:
a video display;
a video controller coupled to said video display and being responsive to an input;
a pointing device, capable of indicating motion in two directions and providing a signal corresponding to said motion to said input;
said video controller being configured to display a menu, and to select among items on said menu in response to motion in a first direction, and to select an aspect of a selected menu item in response to motion in a second direction.

2. The system of claim 1 wherein motion in said first direction indicates function, and motion in said second direction indicates value.

3. The system of claim 2 wherein deactivation of said pointing device selects a value for a selected function.

4. The system of claim 1 further comprising:
a pointing surface on said pointing device;
means, connected to said pointing surface, for detecting contact with said pointing surface and, responsive thereto, sending an activation signal to said video controller; and
said video controller being configured to display said menu in response to said activation signal.

5. The system of claim 1 wherein said pointing device is a touchpad.

6. The system of claim 5 further comprising means for detecting a tap on said touchpad, and sending an additional control signal in response to said tap.

7. The system of claim 1 wherein said menu items include volume and channel.

8. The system of claim 1 wherein:
said menu items are vertically arranged on said display; and
selection of a menu item activates a horizontal display corresponding to values of the selected menu item.

9. The system of claim 1 wherein said pointing device is mounted in a remote control unit, and further comprising:
a wireless transmitter mounted in said remote control unit; and
a wireless receiver coupled to said video controller.

10. A remote control and display system comprising:
a video monitor including
a video display;
a video controller coupled to said video display and being responsive to an input;
a wireless receiver coupled to said video controller;
a remote control unit including
a pointing device, capable of indicating motion in two directions and providing a signal corresponding to said motion to said input;
a wireless transmitter mounted in said remote control unit; and
said video controller being configured to display a menu, and to select among functions on said menu in response to motion in a first direction, and to select a value of a selected function in response to motion in a second direction.

11. A remote control and display system comprising:
a video monitor including
a video display;
a video controller coupled to said video display and being responsive to an input;
a wireless receiver coupled to said video controller;
a remote control unit including
a touchpad, capable of indicating motion in two directions and providing a signal corresponding to said motion to said input;
a wireless transmitter mounted in said remote control unit; and
said video controller being configured to display a menu, and to
select among functions on said menu in response to motion on said touchpad in a substantially vertical direction, causing a horizontal value display for a selected function to be activated,
and to move and indicator horizontally along said horizontal value display in response to motion on said touchpad in a substantially horizontal direction,
and to select a currently indicated value upon termination of contact with said touchpad by a user.
